(19) United States
(12) Patent Application Publication
(10) Pub. No.: US 2017/0067523 A1
(43) Pub. Date: Mar. 9, 2017

(54) BRAKE PISTON HEAD FOR A DISK BRAKE DEVICE, BRAKE PISTON AND DISK BRAKE DEVICE

(71) Applicant: TMD Friction Services GmbH, Leverkusen (DE)

(72) Inventors: Enrique WEGMANN, Leichlingen (DE); Olav BORGMEIER, Hueckeswagen (DE); Stefan EIDEN, Bergisch-Gladbach (DE)

(73) Assignee: TMD Friction Services GmbH, Leverkusen (DE)

(21) Appl. No.: 15/303,374

(22) PCT Filed: May 6, 2015
(86) PCT No.: PCT/EP2015/059920

§ 371 Date: Nov. 16, 2016

(30) Foreign Application Priority Data
May 7, 2014 (DE) 10 2014 106 330.9

(51) Int. Cl. F16D 65/18; F16D 55/225

(52) U.S. Cl. CPC F16D 65/18; F16D 55/225; F16D 2125/06

(57) ABSTRACT

The invention relates to a brake piston head (1) for a disc brake device (100) for transmitting the braking force from a brake piston (200) to a friction lining carrier plate (300), having a force input area (10) on the brake piston side and a force output area (20) facing the friction lining plate (300), wherein the cross-sectional area (21) of the brake piston head (1) is greater in the force output area (20) than the cross-sectional area (11) thereof in the force input area (10), wherein the geometry of the brake piston head (1) is chosen on the basis of the material thereof, the cross-sectional surface area (11) thereof in the force input area (10) and/or the installation height (h) thereof, predefined by the disc brake device (100), in such a way that substantially all of the force field lines introduced into the force input area (10) by the brake piston (200) are transferred through the brake piston head (1) into the friction lining carrier plate (300) in a manner distributed over substantially the whole cross-sectional area (21) of the force output area (20).

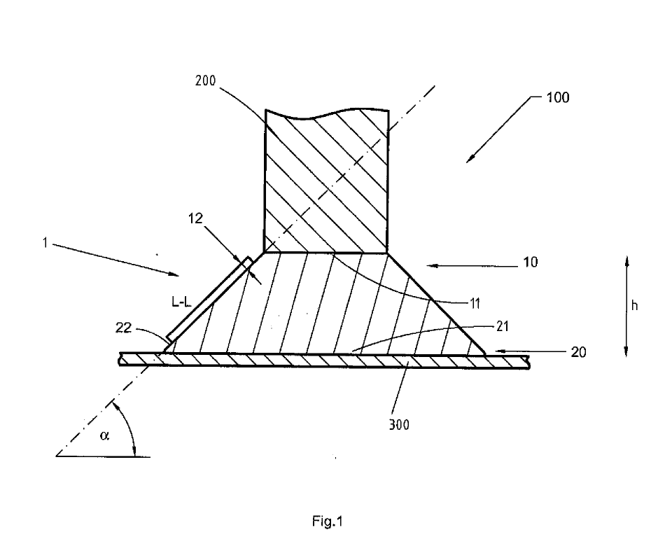

### CROSS-REFERENCE TO RELATED APPLICATIONS

This application is a national stage application (under 35 USC §371) of PCT/EP2015/059920, filed May 6, 2015, which claims benefit of German application No. 10 2014 106 330.9, filed May 7, 2014, the contents of each of which are incorporated by reference herein.

### BACKGROUND OF THE INVENTION

Technical Field and State of the Art

The invention relates to a brake piston head for a disc brake device, to a brake piston as well as to a corresponding disc brake device, whereby the brake piston head is configured to transfer braking force from a brake piston to a friction lining backplate.

Brake piston heads, brake pistons and disc brake devices of the above-mentioned type are known from the state of the art. Modern motor vehicle brakes are usually actuated either hydraulically or pneumatically. In this context, compressed air or brake fluid is employed to exert force onto a friction lining, as a result of which the friction lining is pressed against an element that can be rotated relative to the friction lining. Prior-art brake systems are, for example, drum brakes and disc brakes, in which the friction lining is pressed against a brake drum or a brake disc for braking purposes. In the case of high-performance applications, disc brakes are used most often since they permit better heat dissipation than drum brakes and, as a result, can yield a better braking performance without overheating. Friction, which produces heat, is generated when the friction lining is pressed against the brake disc. This process converts kinetic energy into thermal energy and the motor vehicle slows down as a function of the loss of kinetic energy.

The friction lining is normally applied onto or attached to a lining backplate since the friction lining is usually elastic and thus not sufficiently stable itself for the direct transmission of force. The appertaining braking force is usually applied by means of hydraulically or pneumatically actuated brake cylinders which act against the back of the lining backplate. Brake piston heads can be arranged between the brake cylinders and the friction lining plate, and in some configurations, they are an integral part of the brake pistons. In other configurations, the brake piston heads are configured separately from the brake pistons.

German patent application DE 10 2005 009 398 A1 describes, for instance, a pair of brake linings for a disc brake, whereby the lining backplate has different configurations and dimensions that are appropriately adapted to the loads that are encountered in each case, especially flexural loads, and to the installation space of a brake caliper. For instance, it is provided there for the lining backplate to be configured as a cast part, whereby the lining backplate can have indentations and/or elevations as well as holes which create a corresponding positive fit with the friction lining. In this context, the lining backplate is preferably made as a cast part, thus allowing flexible shaping of the lining backplate, for instance, with reinforcement ribs or positive-fit parts.

The configuration of lining backplates as cast parts rather than as a sheet metal part such as, for example, a steel plate, only becomes cost-effective at a high number of units. Such high unit numbers are usually not manufactured in the utility vehicle market since the various systems are too diverse. Even taking the spare parts business into consideration, the unit numbers that can be achieved here are not conducive for such a configuration.

German patent application DE 10 2008 019 003 A1 discloses a brake lining, especially for the brakes of utility vehicles, also an appertaining adapter as well as a utility vehicle disc brake equipped with the brake lining and the adapter. The brake lining has a backplate on which the friction lining is arranged, whereby the backplate has at least one force-introduction zone which faces away from the friction lining and by means of which an adapter that is operationally connected to a brake tappet comes into contact when the brake is in the operating position, whereby, in order to affix the adapter and the backplate, at least in the radial direction and in the circumferential direction relative to the brake disc geometry, the backplate is provided with holding means which match holding means that are present on the adapter side.

German patent application DE 38 12 037 A1 discloses a mechanically actuated sliding-caliper disc brake having an anchor plate and a caliper with two legs, whereby the legs extend over a brake disc that is non-rotatably joined to the wheel. A piston that can be moved parallel to rotational axis of the brake disc is mounted in the first leg of the brake caliper.

German patent application DE 2 009 260 A discloses a spot-type disc brake that has a U-shaped anchor plate surrounding the brake disc from the outside and that has a floating caliper likewise surrounding the brake disc from the outside. Moreover, for purposes of a simple replacement of the brake lining, an intermediate part is provided which can be removed in one piece so that the floating caliper can be easily disassembled.

The translation of a European patent specification, DE 600 19 319 T2, discloses a piston for a cylinder-and-piston unit of a disc brake; it has a head and a body which are configured to come into contact with a brake lining in order to act upon a brake disc. The head and the body surround a shaft or a recess for the shaft, thereby forming a space for a ring damping element that is arranged between the head and the body and that damps vibrations caused by a braking action in the head of the piston.

British patent application GB 2 123 909 A discloses a disc brake with a brake disc having brake linings arranged on both sides of the brake disc as well as a brake caliper that can be moved axially and that has a piston that presses one of the brake linings against the brake disc.

U.S. Pat. Appln. No. 2004/00795696 A1 discloses a brake caliper having a brake lining and a piston for purposes of exerting a force onto the brake lining. The brake piston has a brake piston head that is configured so as to be hollow.

British patent document GB 742,338 is aimed at putting forward a service-friendly disc brake in which the friction linings can be easily inspected and replaced when necessary. Between the lining backplate and the brake piston, a conical pressure piece is sunk into a frusto-conical recess in the brake piston and it is completely surrounded by it. As a result, the force-introduction zone is at least as large (cross-sectional surface area) as the force-dissipation zone.

International patent application WO 01/65153 A1 relates to a gasket for, or to the sealing of, a piston shaft. The described brake device has a brake piston head whose force-dissipation zone or whose total volume has the shape of a rectangle or of a cuboid. This brake piston head strikes the lining backplate perpendicularly.

Japanese patent application JP H07 42769 A discloses a disc brake device which makes it possible to dispense with a return spring or retracting spring for the brake lining. For this purpose, an elastic connection element is sunk into the brake piston. The brake piston surrounds this element. The force-introduction zone is larger than the force-dissipation zone.

For several reasons, it is also desirable in the sector of utility vehicles to employ lightweight materials in the realm of the brake systems. These reasons include, on the one hand, the weight reduction that can be achieved in this manner as well as, on the other hand, a better thermal behavior of certain lightweight materials in comparison to conventional materials. Since very high braking forces, for example, in the order of magnitude of about 200 kN, are needed specifically in the case of heavy utility vehicles, conventional brake systems that are made of lightweight materials at critical places cannot withstand the high loads. Under the effect of a load, the lightweight materials can be permanently deformed, which can impair the safety and functionality of the brakes. Therefore, the use of lightweight materials, especially in the area of a lining backplate, is not readily possible and is usually avoided nowadays.

Before this backdrop, it is an objective of the invention to refine a disc brake device of the above-mentioned type so that it allows the use of lightweight materials, especially lightweight lining backplates, particularly in utility vehicles.

### SUMMARY OF THE INVENTION

A brake piston head according to the invention for use in a disc brake device serves to transfer braking force from a brake piston to a friction lining backplate. The brake piston head has a force-introduction zone on the brake piston side and a force-dissipation zone facing the friction lining backplate. The cross-sectional surface area of the brake piston head in the force-dissipation zone is larger than the cross-sectional surface area in the force-introduction zone.

Within the scope of the invention, it is provided that the geometry of the brake piston head is selected on the basis of its material, its cross-sectional surface area in the force-introduction zone and/or its installation height which is prescribed by the disc brake device, and this selection is made in such a way that substantially all of the force field lines introduced into the force-introduction zone by the brake piston are transmitted into the friction lining backplate all the way through the brake piston head so as to be distributed over the entire cross-sectional surface area or else substantially over the entire cross-sectional surface area of the force-dissipation zone.

This achieves that the forces introduced into the force-introduction zone via the brake piston are distributed substantially over the entire surface area of the force-dissipation zone of the brake piston head. The distribution of the force dissipation in the force-dissipation zone involves a force introduction over the surface into the friction lining backplate, thus avoiding stress peaks in the friction lining backplate.

This counteracts a possible deformation of the friction lining backplate, thus allowing the use of friction lining backplates made of lightweight materials. Thanks to the brake piston head according to the invention, lightweight materials can be employed in areas where such materials could not be used before.

The brake piston head according to the invention is configured as a solid body. It has been found that the transmission of force field lines over the entire cross-sectional surface area of the force-dissipation zone can be achieved particularly effectively with solid bodies. Moreover, solid bodies are easy to produce.

According to the invention, an imaginary connecting line that, in a longitudinal section through the brake piston head connects directly opposite cross-sectional surface area edges of the force-introduction zone and of the force-dissipation zone to each other, has an angle between 25° and 55° relative to the cross-sectional surface area in the force-dissipation zone. It has been found that, owing to such a geometry of the brake piston head, it is possible to attain such a distribution of force field lines through the brake piston head. Moreover, this allows a corresponding enlargement of the surface area of the force-dissipation zone in comparison to the force-introduction zone.

In a first conceivable refinement of the invention, it is provided that the geometry of the brake piston head is selected on the basis of its material, its cross-sectional surface area in the force-introduction zone and/or its installation height which is prescribed by the disc brake device, and this selection is made in such a way that all of the force field lines introduced by the brake piston into the force-introduction zone or substantially all of the force field lines introduced into the force-introduction zone by the brake piston are transmitted into the friction lining backplate so as to be homogenously distributed over the entire cross-sectional surface area of the force-dissipation zone or else substantially over the entire cross-sectional surface area of the force-dissipation zone. Therefore, in each case, the partial surface pressures in the partial areas of the force-dissipation zone are substantially the same.

Another embodiment of the invention addresses the fact that the friction lining backplate can have geometries such that they influence the force introduction. Thanks to a complementary adaptation of the geometry of the brake piston head to the friction lining backplate in such a way, it is nevertheless possible to achieve a homogenous force introduction.

Another refined aspect of the brake piston head according to the invention provides for the geometry of the brake piston head to be selected in such a way that the transmitting force field lines extend substantially through the entire brake piston head. In this manner, the brake piston head is designed in such a way that it is stressed uniformly throughout, and no appreciable stress differences occur in the brake piston head itself. This reduces the mechanical load on the brake piston head and contributes to prolonging its service life. Moreover, the dimensions of the brake piston head are reduced within the scope of this configuration of the invention, so that the brake piston head is lightweight and there is no superfluous weight.

According to another refined embodiment of the brake piston head, it can be provided that, in the cross section from the force-introduction zone to the force-dissipation zone, the brake piston head widens monotonically, especially gradually or continuously. In this manner, the force introduced via the force-introduction side of the brake piston head is dissipated over a larger surface area, as a result of which the brake pressure is distributed more effectively. As a result, the lining backplate is stressed more uniformly and with lower partial surface pressures. The stress differences in the lining backplate can be reduced, thereby diminishing the risk of deformation of the lining backplate. Whether a gradual or continuous widening is selected can also depend on the installation space available in a given brake.

In accordance with another possible embodiment of the brake piston head according to the invention, it can be provided for the edges of the brake piston head in the force-dissipation zone to be beveled and/or rounded-off, whereby the rounding radius especially amounts to between 2 mm and 10 mm. Providing a bevel on the edges of the brake piston head or providing appropriate rounding makes it possible to prevent force peaks from being transferred beyond the outer layers of the brake piston head, in other words, into the edge areas. This improves the distribution of the force field lines, especially a homogenous distribution, through the brake piston head over the entire cross-sectional surface area of the force-dissipation zone. Rounding radii between 2 mm and 10 mm have proven to be particularly well-suited.

In another aspect of a brake piston head according to the invention, the brake piston head is configured so as to be substantially or completely conical, especially frusto-conical. On the basis of appropriate calculations, it was found that conical brake piston heads are well-suited to distribute force field lines over the entire cross-sectional surface area of the force-dissipation zone.

Another possible embodiment of the brake piston head according to the invention provides for the diameter of the cross-sectional surface area of the force-dissipation zone to amount to between 20 mm and 120 mm, especially between 40 mm and 90 mm. This makes it possible to attain contact of the brake piston head over a large surface area of a friction lining backplate.

A first independent subject matter of the invention relates to a brake piston having a brake piston head according to the invention. Such a brake piston head makes it possible to employ lightweight materials, for instance, aluminum alloys, in the realm of high-performance systems, especially in the utility vehicle sector.

In accordance with a refined aspect of the brake piston according to the invention, the brake piston head and the brake piston can be configured as a single part or in multiple parts. Single-part configurations facilitate the assembly of such a brake, while multiple-part configurations can facilitate the standardization of components.

Another independent subject matter of the invention relates to a disc brake device with at least one friction lining backplate as well as at least one brake piston head and/or at least one brake piston of the type described above. Such a disc brake device can be made of lightweight materials, especially with lining backplates made of lightweight materials such as aluminum.

In accordance with another conceivable aspect of the disc brake device according to the invention, it can be provided for the material of the brake piston head to be adapted to the material of the friction backplate, especially to the material of the friction lining backplate. In this manner, the thermal expansion behavior can be optimized and the probability of deformation can be reduced. Also within the scope of aspects of heat dissipation, the use of identical or similar materials can prevent jumps in the thermal conductivity properties which would impair heat dissipation.

Additional objectives, advantages, features and application possibilities of the present invention ensue from the description below of an embodiment with reference to the drawing. In this context, all of the described and/or depicted features, either on their own or in any meaningful combination, constitute the subject matter of the present invention, also irrespective of their compilation in the claims or in the claims to which they refer back.

### DESCRIPTION OF THE DRAWING

The invention will be described on the basis of an embodiment. In this context, the single FIGURE schematically shows a sectional view through a disc brake arrangement according to the invention.

### DETAILED DESCRIPTION

The disc brake arrangement has a brake piston head 1 that is situated between a brake piston 200 and a friction lining backplate 300. In the embodiment being presented here, the brake piston 200 is cylindrical. In the embodiment being presented here, the friction lining backplate 300 is planar on the side facing the brake piston head 1. In alternative embodiment variants, the friction lining backplate 300 can be profiled on the side facing the brake piston head 1. In this case, a force-introduction zone can be structured so as to be complementary to the appertaining brake piston head.

The brake piston head 1 is likewise rotation-symmetrical and, in the embodiment shown, configured so as to be frusto-conical. The brake piston head 1 is made of a solid material. It does not have any hollow spaces and it is not made of a composite. The friction lining backplate 300 and the brake piston head 1 are made of the same materials, in this case, of a lightweight aluminum alloy.

The brake piston head 1 has a force-introduction zone 10 via which the force of the brake piston 200 is introduced into the brake piston head 1. End faces of the brake piston 200 and of the force-introduction zone 10 of the brake piston head 1 are configured so as to be complementary to each other, in this case, so as to be planar.

The force-introduction zone 10 has a cross-sectional surface area 11 having a first size. The force-introduction zone 10 has a cross-sectional surface area 21 that is larger than the cross-sectional surface area 11 of the force-introduction zone 10.

As a result, a connecting line L-L between an edge 12 of the cross-sectional surface area 11 of the force-introduction zone 10 and an edge 22 of the cross-sectional surface area 21 of the force-dissipation zone 20 encloses an angle α vis-à-vis the cross-sectional surface area 21, said angle α being between 0° and 90°, depending on the cross-sectional surface areas and on the installation height h. It has been found that angles α between 25° and 45° allow a structure according to the invention for an appropriate brake piston head 1.

The brake piston head 1 according to the invention is rounded-off at the cross-sectional surface area edge 22. The rounding radius R of in this case is about 2 mm.

The brake piston head 1 utilizes the so-called arch effect, which permits a uniform distribution of force field lines from the force-introduction surface 10 to the force-dissipation surface 20. Consequently, the force field lines introduced via the force-introduction zone 10 are homogenously distributed over the entire cross-sectional surface area 21 of the force-dissipation zone 20. Stress peaks in this zone are effectively avoided.

### LIST OF REFERENCE NUMERALS

1 brake piston head
10 force-introduction zone
11 cross-sectional surface area of the force-introduction zone
12 edge of the cross-sectional surface area
20 force-dissipation zone
21 cross-sectional surface area of the force-dissipation zone
22 edge of the cross-sectional surface area
100 disc brake device
200 brake piston
300 friction lining backplate
h installation height
L-L connecting line
R rounding radius
α angle

1. A brake piston head (1) for use in a disc brake device (100) in order to transfer braking force from a brake piston (200) to a friction lining backplate (300), comprising:
a solid body having a force-introduction zone (10) on the brake piston side and a force-dissipation zone (20) facing the friction lining backplate (300), wherein the brake piston head (1) has a cross-sectional surface area in the force-dissipation zone (20) that is larger than its cross-sectional surface area (11) in the force-introduction zone (10), and wherein the geometry of the brake piston head (1) is selected on the basis of its material, its cross-sectional surface area (11) in the force-introduction zone (10) and/or of its installation height (h) which is prescribed by the disc brake device (100), and this selection is made in such a way that substantially all of the force field lines introduced by the brake piston (200) into the force-introduction zone (10) are transmitted into the friction lining backplate (300) all the way through the brake piston head (1) so as to be distributed substantially over the entire cross-sectional surface area (21) of the force-dissipation zone (20), and wherein an imaginary connecting line (L-L) that, in a longitudinal section through the brake piston head (1) connects directly opposite cross-sectional surface area edges (12; 22) of the force-introduction zone (10) and of the force-dissipation zone (20) to each other, has an angle between 25° and 55° relative to the cross-sectional surface area (21) in the force-dissipation zone (20).

2. The brake piston head (1) according to claim 1, wherein the geometry of the brake piston head (1) is selected on the basis of its material, its cross-sectional surface area (11) in the force-introduction zone (10) and/or its installation height (h) which is prescribed by the disc brake device (100), and this selection is made in such a way that substantially all of the force field lines introduced by the brake piston (200) into the force-introduction zone (10) are transmitted into the friction lining backplate (300) so as to be homogenously distributed substantially over the entire cross-sectional surface area (21) of the force-dissipation zone (20).

3. The brake piston head (1) according to claim 1, wherein the geometry of the brake piston head (1) is selected in such a way that the transmitting force field lines extend substantially through the entire brake piston head (1).

4. The brake piston head (1) according to claim 1, wherein in the cross section from the force-introduction zone (10) to the force-dissipation zone (20), the brake piston head (1) widens monotonically.

5. The brake piston head (1) according to claim 1, wherein the edges of the brake piston head (1) in the force-dissipation zone (20) are beveled or rounded-off.

6. The brake piston head (1) according to claim 1, wherein the brake piston head (1) is configured so as to be substantially conical or frusto-conical.

7. The brake piston head (1) according to claim 6, the cross-sectional surface area (21) of the force-dissipation zone (20) has a diameter (A) in the range of between 20 mm and 120 mm.

8. A brake piston (200) having a brake piston head (1) according to claim 1.

9. The brake piston (200) according to claim 8, wherein the brake piston head (1) and the brake piston (200) are configured as a single part.

10. A disc brake device (100) with at least one friction lining backplate (300) in combination with at least one brake piston according to claim 8.

11. The disc brake device (100) according to claim 9, wherein the material of the brake piston head (1) is adapted to the material of the friction backplate (300).

12. The brake piston (200) according to claim 8, wherein the brake piston head (1) and the brake piston (200) are configured in multiple parts.
